(19) United States
(12) Patent Application Publication
(10) Pub. No.: US 2021/0210219 A1
(43) Pub. Date: Jul. 8, 2021

(54) Anti Matter Fusion Energy Production

(71) Applicant: William Barney Webb, Lake City, MN (US)

(72) Inventor: William Barney Webb, Lake City, MN (US)

(21) Appl. No.: 17/082,310

(22) Filed: Oct. 28, 2020

Related U.S. Application Data
(60) Provisional application No. 62/974,136, filed on Nov. 18, 2019.

(51) Int. Cl. G21B 1/15; G21B 1/05

(52) U.S. Cl. CPC G21B 1/15; G21B 1/055; G21B 1/057

(57) ABSTRACT

This invention has evolved from the discovery of how to correctly blend Einstein's Special Relativity into nuclei and atoms. That blending greatly simplifies understanding of nuclear physics. Pairs of electrically neutral relativistically warped nuclei share a huge configuration electrostatic “nuclear strong force” with a “1/r to the 5.3 power” short range. This strong force can be either repulsive or attractive. The attractive strong force causes pairs of neutralized anti matter protons and neutralized deuterons to attract, fuse, dewarp and produce an enormous amount of relativistic mass energy. The new constituents of plasma in Tokamak and Stellarator magnetic confinement machines will consist of protons, deuterons and, for the first time ever, electrons. There is no residue from this relativistic nuclear fusion reaction. The neutrinos produced pass quickly through the walls of the reaction vessel and leave earth.

### BACKGROUND OF THE INVENTION

An on-line search of Wikipedia's “List of Fusion Experiments” shows that none of the approximately fifty Tokamak test reactors, that have been built world wide, has yet to produce more energy than energy consumed. At least a dozen Tokamaks have been shut down. This same search shows that none of the approximately forty Stellarator test reactors, that have been built world wide, has yet to produce more energy than energy consumed. Several dozen Stellarators have been shut down. There are also several Implosion test reactors that have yet to produce more energy than consumed.

What do all of these failing Tokamak, Stellarator and Implosion test reactors have in common? They all have used the technology of the Standard Model of the Atom. The Standard Model does not incorporate Special Relativity in its description of the structure of its atoms and nuclei. Standard Model practitioners have never written about the warped mass, warped length, warped time or other warped properties, of their Standard Model little round ball point-like electrons, positrons and nucleons.

The Standard Model asserts its ineptness. After 44 calendar years, billions of public and private dollars spent and thousands of scientist-years of designing, building and experimenting, no Standard Model fusion energy test has yet to produce more energy than energy consumed.

New discoveries have been made over the last decade showing how to correctly blend Einstein's Special Relativity into nuclei and atoms. That blending greatly simplifies understanding of nuclear physics. This inventor and his associate scientists have, over the evolving years, mathematically analyzed every new blending discovery. The mathematics of proven physical laws have been used by this inventor, a registered professional engineer (retired); and must continue to be used by evaluators, as the singular unbiased judge of correctness.

### BRIEF SUMMARY OF THE INVENTION

This invention has evolved from the discovery of how to correctly blend Einstein's Special Relativity into nuclei and atoms. It has been discovered that electrons, positrons and quarks are photon-circles. A photon-circle is an Einstein photon whose length has been warped to a closed circular shape.

Photon-circles have their circumferential length congruent with their circular orbit. Their distributed electrical charge causes them to electrostatically self-tension to a circular shape. That outward acting self-tensioning force also eliminates negative electrostatic potential energies. Photon-circles are thereby always properly governed by Special Relativity. Their mass, length and time are warped. All their other on-board physical properties containing any dimension of mass, length or time are also warped. They create a surrounding field-of-warpage.

The two outside quarks and single center quark in nuclei are relativistically warped to different sizes. Photon-circle quarks use electrostatic attractive and repulsive forces to bind their nuclear threesome. The nuclear threesomes of this document's fusing nuclei are composed of 69.6% rest mass and 30.4% relativistic mass.

Extreme relativistic warpage of the mass density in the core of our sun, and other stars, causes the nuclei of Hydrogen's two stable isotopes, protons and deuterons, to electron capture. They capture their own atom's electron and transmute to neutral charged anti matter protons and neutral charged deuterons. Pairs of those two nuclei share a huge short-range-configuration-electrostatic-attractive-force that causes them to attract, fuse, dewarp and produce an enormous amount of relativistic mass energy.

Tokamak and/or Stellarator machines will be modified and used to implement this Anti Matter Fusion Energy Production method. The new plasma will consist of positive charged protons and deuterons, and for the first time ever, negative charged electrons. The negative electrons will circulate in the opposite direction to that of the protons and deuterons and will attract to, combine with, and neutralize the protons and deuterons. The neutralized plasma will then leave magnetic confinement to consummate fusion near the walls of the Tokamak/Stellarator. There is no residue from this relativistic nuclear fusion reaction. The neutrinos produced pass quickly through the walls of the reaction vessel and leave earth. Fusion heat energy will be withdrawn for conversion to useful energy.

### BRIEF DESCRIPTION OF THE DRAWINGS

The present invention has been described herein with reference to the attached drawings which are given as non-limiting examples only, in which:

FIG. 1 represents an oblique view of a Photon-Circle Quark.

FIG. 2 represents an oblique view of a rotating Photon-Circle Quark with relativistic length contraction.

FIG. 3A represents an oblique view of the neutron's threesome of warped Photon-Circle Quarks.

FIG. 3B represents an oblique view of the neutron nucleus' electrostatic binding forces.

FIG. 4 illustrates the dewarping decay of the neutronium4 nucleus to produce helium.

FIG. 5 is a graph of the resulting quark charge ratios for the dewarping decay of the 29 least massive stable nuclei.

FIG. 6 is a graph of the attractive force equation between two different size warped quarks.

FIG. 7 illustrates the short range nuclear strong repulsive force between two neutrons on a common axis.

FIG. 8 illustrates the short range nuclear strong attractive force between a neutralized anti matter proton and a neutralized deuteron on a common axis.

FIG. 9 illustrates the short range nuclear strong attractive force between a neutralized anti matter proton and a neutralized deuteron shuffling together.

### DETAILED DESCRIPTION OF THE INVENTION

This invention has evolved from the discovery of how to correcctly blend Einstein's Special Relativity into nuclei and atoms. This new technology provides a more accurate understanding of how to correctly achieve energy production from relativistic dewarping of fusing nuclei.

### 1. Photon-Circle Quarks

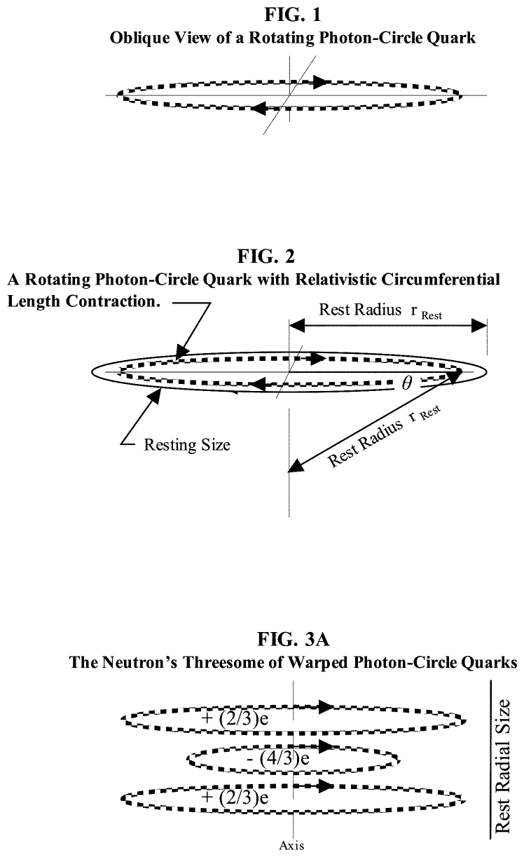

Photon-circle quarks have their circumferential length congruent with their circular orbit. FIG. 1 is an oblique illustration of a photon-circle quark rotating in its orbit.

Photons and photon-circle quarks are varieties of each other. A photon-circle quark is an Einstein Photon whose length has been warped to a closed circular shape. Pair annihilation experiments confirm that colliding quarks can simply transmute back into photons.

When a photon is warped to a closed circular shape, its Maxwell Equation electric and magnetic fields are concentrated to produce the photon-circle quark's electrical charge. When warped to a closed circular shape, its Einstein Photon energy is concentrated to produce the photon-circle quark's mass.

Photon-circle quarks have their electrical charge evenly distributed around their circumferential length. That causes them to electrostatically self-tension to a circular shape. Their outward acting self-tensioning force eliminates negative electrostatic potential energies. Photon-circle quarks are thereby always properly governed by Special Relativity.

Since photon-circle quarks are a variety of the photon, they have their rotational kinetic energy: E=(1/2) mv², also given by the Photon Energy equation: E=hf=hv/λ=hv/n(2π r). That equality produces their quantized structural equation:

$$( mvr ) ( \frac{1}{2} ) = ( \frac{1}{n} ) ( \frac{h}{2 π} ) \qquad ( 1 )$$

The factor (1/2) is their measured spin. The collective factor n (2π r) is the quantum counting of their circumferential length. The ratio of Einstein's two famous energy equations hf/mc² set equal to the dimensionless value β²/2 also produces this same relativistic photon-circle quantized structure equation.

### 2. Particle-Like and Wave-Like.

Rotating Photon-Circles have eliminated their radial electrostatic forces so they are tensioned only by their centrifugal force. Wave speed on a Photon-Circle tensioned only by its centrifugal force can be determined using the physics Wave Speed Equation. The calculation gives: v_{Wave}=v_{P-C}. A Photon-Circle's wave speed and rotation speed are one-and-the-same. Its wave is its rotation. Photon-Circles singularly satisfy the Louis de Broglie “Wave-Particle Nature” of matter. Photon-Circles are, at all times, both fixed-shape-particle-like and also wave-like.

3. Rotating Photon-Circle Quarks Warp in Accord with Special Relativity.

Photon-circle quarks have the normal circumferential length dimension (2π r). When rapidly rotating in their circular orbit, that length dimension, all of which is moving at the same speed, contracts in accord with Special Relativity as shown in FIG. 2.

The photon-circle quark's circumferential length contracts while its radial dimension, which has no motion, remains unchanged. The unchanged radial dimension is shown in the figure being deflected downward through the spatial angle of warpage θ. Comparing the Lorentz Factor \sqrt{(1−β²)} used by Einstein for length contraction, to the length trigonometry in the figure, then produces:

\sqrt{(1−β²)}=cosθ and β=sinθ (2)

Spatial angles of warpage are used so frequently in the relativity of nuclei, that the Cosθ Factor of warpage has been found to be more useful than the Lorentz Factor.

We have illustrated warpage of the circumferential length of a rapidly rotating quark. In accord with Special Relativity, the quark's mass and time are also warped. All other on-board physical properties of quarks containing any dimension of mass, length or time are also warped.

Any Photon-Circle that is rotating so fast that it is relativistically warped, also modifies the space around its structure by creating a surrounding field-of-warpage. The field's warpage diminishes with unwarped radial distance r from the Photon-Circle in accord with 1/r².

The fields-of-warpage of two or more neighboring Photon-Circles are additive. This accounts for their aggregate strength within their material and their aggregate strength extending outside the surface of their material.

Photons traversing in a field-of-warpage are refracted, i.e., they have all their massless physical properties warped. Their speed-of-light is slowed, their wavelength shortened, their frequency diminished, their passage of time made slower and their energy and Planck Constant lessened.

We observe only aggregate fields-of-warpage. Photons passing close to the sun, for instance, are observed to be warped (bent) by the sun's external field-of-warpage.

Relativity is more than just Special or General. Relativity is Universal!

### 4. Photon-Circle Quarks in Nuclei are Warped to Different Sizes.

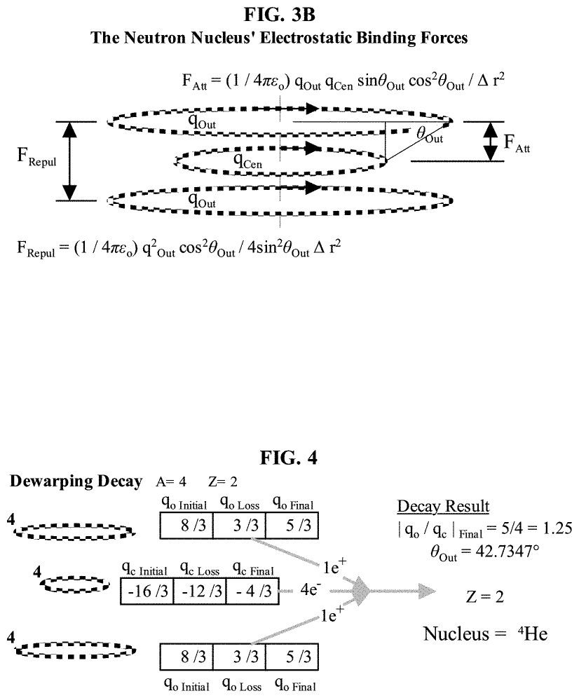

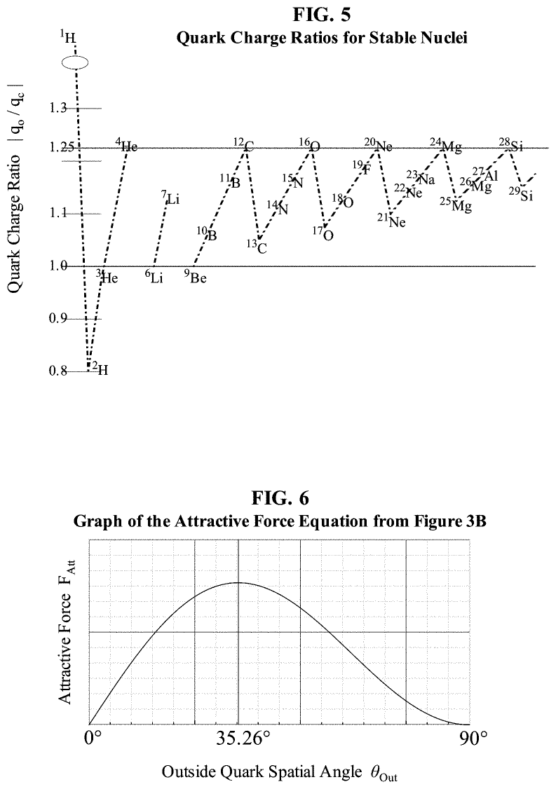

The two outside quarks and single center quark in nuclei are relativistically warped to different sizes. Photon-circle quarks then use electrostatic attractive and repulsive forces to bind their nuclear threesome. FIG. 3A is an illustration of the three warped quarks of a Neutron.

FIG. 3B uses an outside quark's spatial angle of warpage θ_{Out} in the Coulomb Equations of electrostatic attraction and repulsion to analyze binding of the neutron.

When the quark threesome is at balance F_{Repul}=F_{Att}. That equality produces the equation of balance for all nuclear threesomes:

|q_{Out}/q_{Cen}|=4sin³θ_{Out} (3)

The Neutron has a quark charge ratio |q_{Out}/q_{Cen}|=0.50 so its two outside photon-circle quarks both have a spatial-angle-of-warpage: θ_{Out}=30°. The center photon-circle quark then has its spatial angle of warpage determined from geometry to be: θ_{Cen}=(90°−30°)=60°.

The relativistic warped mass of the Neutron is now defined by the equation:

$$( \frac{{m}_{Rest}}{cos 30 °} ) + ( \frac{{m}_{Rest}}{cos 60 °} ) = 4.309401 {m}_{Rest} . \qquad ( 2 )$$

The rest mass of the three quarks is 3 m_{Rest}. Rest mass makes up 3/4.309401=69.6% of the total mass. Relativistic mass makes up the remaining 30.4%.

5. Photon-Circle Quarks are like Laser Photons. They can Synthesize.

Numerous photon-circle quarks can occupy the same space at the same time. This synthesis is called quarksynthesis.

We previously illustrated a Neutronium1, the Neutron. NeutroniumAs are a quarksynthesis of numerous Neutrons that have A times more mass and A times more electrical charge. All NeutroniumAs have the same quarksynthesized size and shape as the Neutron.

FIG. 4 illustrates the dewarping decay of the Neutronium4 nucleus decaying to the stable ⁴He nucleus. In the figure, the Neutronium4 threesome of quarks is fitted with mathematical scoreboards at the right end of each quark to keep track of changing quark charges.

Decay of Neutronium4 is especially aggressive: a simultaneous emission of both photon-circle electrons and photon-circle positrons. The numbers of electrons and positrons emitted is determined by basic quark charges. Every quark has a basic quantum of charge ±(1/3) e. A synthesized quark with mass number A will never naturally decay to a charge less than ±A(1/3) e.

To maintain balance, positrons are always emitted in pairs: the same number from each of the outer quarks. Thus, there is always an even number of positrons emitted. If the emission's final atomic number Z is an even number, the number of electrons emitted is then even. If the emission's final atomic number Z is odd, the number of electrons emitted is odd.

The arrows leading from the scoreboards show the number of electrons emitted from the center quark and the number of positrons emitted from each outer quark. For the ⁴He nucleus, four electrons are first emitted from the center quark. Expanding outward, these four electrons come close to the positrons in the outer quarks. Their separation distance is halved and their electrostatic attraction increased by a factor of four. One positron from each outer quark delaminates to join an electron and pair annihilate producing two gamma photons. The net emission is then four gamma photons and two electrons. ⁴He results.

The scoreboard for each quark keeps track of its initial charge, loss of charge due to its dewarping decay and resulting final charge. For this Neutronium4, the initial quark charge ratio was 0.50. The final more stable quark charge ratio resulting from dewarping decay is |q_{Out}/q_{Cen}|=1.25. Decay has maximized the ⁴He quark charge ratio at 1.25.

The graph of FIG. 5 plots the resulting quark charge ratios for the dewarping decay of the 29 least massive stable nuclei. Notice the saw tooth symmetry between this graph and a graph of Nuclear Binding Energies for those same nuclei. Maximum charge ratios are found to correspond to maximum Binding Energies for every fourth nucleus and there is a narrowing of charge ratios at higher mass numbers.

### 6. Slope of the “Chart of the Nuclides”

The nuclear attractive force equation F_{Att}=(1/4 πεₒ)q_{Out}q_{Cen} sinθ cos²θ/Δr², from FIG. 3B, is graphed in FIG. 6. The outside quark's spatial angle of warpage producing the maximum binding force is: θ_{Max}=tan⁻¹[1/\sqrt{(2)}]=35.26°. From equation (3), the quark charge ratio corresponding to this maximum is: |q_{Out}/q_{Cen}|=4 sin³ (35.26°)=0.7698. This charge ratio can be used to mathematically determine the slope of the nucleosynthesis style “Chart of the Nuclides” as follows. When a NeutroniumA decays by electron emission, a number Z of nucleosynthesis electrons are emitted from its dewarping center quark. Its nucleosynthesis quark charge ratio would then increase in accord with

$$\vert {q}_{Out} / {q}_{Cen} \vert = \frac{2}{3} A / ( \frac{4}{3} A - \frac{3}{3} Z ) .$$

The segregating slope equation is determined by combining this equation having quark charge ratio 0.7698=2 A/(4 A−3Z) with the assumption of nucleosynthesis A=N+Z to eliminate A and derive the initial slope of the Chart as Z=0.878 N, and equally, N=1.139 Z. The spatial-angle-of-warpage 35.26°, which produces the maximum electrostatic binding force in nuclei, segregates 69 electron emitting nuclei from 64 electron captor/positron emitter nuclei in the lower end of Chart of the Nuclides for mass numbers 1 thru 29. This provides outstanding agreement with a huge amount of experimental data.

### 7. NeutroniumAs are Dark Matter.

FIG. 7 shows two photon-circle Neutrons (Neutronium1s) in close proximity on a common axis. There are nine Coulomb electrostatic attractive and repulsive forces between the two Neutrons. The five repulsive force pairings, shown on the right, all act parallel to the axis-of-separation. The four attractive force pairings, shown on the left, all act at angles to the axis-of-separation. The attractive forces begin to diminish as separation distances become small due to their increasing angles. An unbalanced electrostatic repulsive force then quickly builds between the two Neutrons.

Coulomb's equation is used nine times to calculate forces for each separation distance. Here are calculated net forces for two Neutrons at five different center-to-center separations:
At 20.00 Fermi, net repulsive force is 0.0023 N,
“10.00 Fermi 0.050 N,
“ 3.65 Fermi 3.321 N,
“ 2.34 Fermi 22.28 N,
“ 1.00 Fermi 1,922.0 N.

These remarkable net forces are a configuration-electrostatic-repulsive-force between two electrically neutral photon-circle Neutrons. The repulsive force has a short range. In the range between 2.34 and 1.0 Fermi, for instance, this net force is acting like a “1/r to the 5.3 power” force. This is indeed a strong force with a short range occurring between neighboring nuclei.

If the Neutrons in the above analysis were replaced by two NeutroniumAs, one with mass number A₁ and the second with mass number A₂, the above forces would be even larger by the product: A₁×A₂.

Neutral charged Neutrons and NeutroniumAs form dark matter. They have a huge short-range-configuration-electrostatic-repulsive-force that allows them to compact to an exceptionally high density, but not to an infinite density.

This same type of huge short-range-electrostatic-repulsive-strong-force is found to build between neighboring Lithium and Deuterium nuclei hindering success in ongoing Tokamak experiments.

### 8. Stellar Fusing Nuclei.

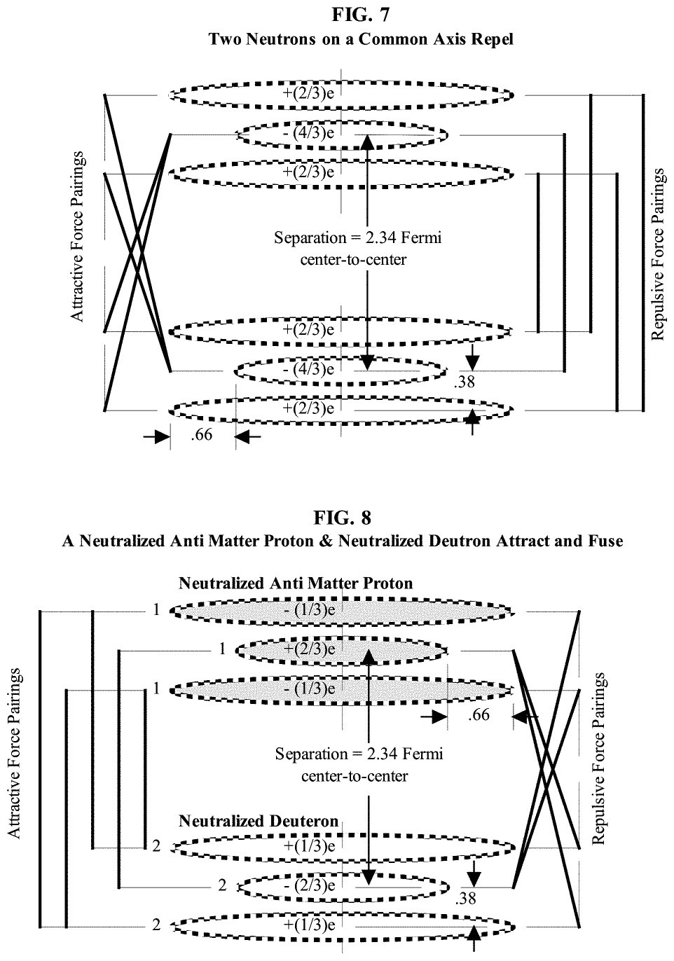

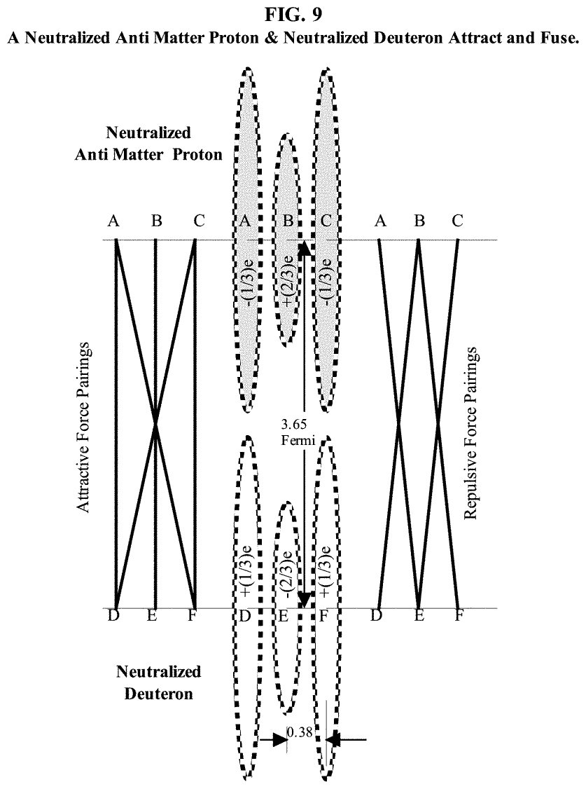

Extreme relativistic warpage of the mass density in the core of our sun, and other stars, causes the nuclei of Hydrogen's two stable isotopes, protons and deuterons, to electron capture. They capture their own atom's electron and transmute to neutral charged anti matter protons and neutral charged deuterons as shown in FIG. 8. Pairs of those two nuclei share a huge short-range-configuration-electrostatic-attractive-force that causes them to attract, fuse, dewarp and produce an enormous amount of relativistic mass energy.

Neutral charged anti matter protons are unique. When ¹H atoms capture their electron and become electrically neutral, their neutralization also causes these least massive nuclei to transpose the location of their positive and negative charged quarks. The two outside quarks now have negative charge and the single center quark now has positive charge. The resulting transposed charge is shown in FIG. 8.

The anti matter protons are the only known nuclei to have quarks with transposed electrical charges. Those transposed charges account for the anti matter proton's huge short-range-configuration-electrostatic-attractive-force that causes attraction to, and fusion with, a neutral charged deuteron.

FIG. 8 also shows that these two neutral charged nuclei have identical warped size and shape. They have the same size and shape as the neutroniums. Similitude of size and shape is a necessary factor for these two nuclei to attract and fuse. The anti matter proton will not, for instance, attract and fuse with a normal proton which is much larger in size, or with stable nuclei, like that of ⁴He, ¹²C, ¹⁶O, ²⁰Ne, ²⁴Mg, ²⁸Si, etc., all of which have identical size and shape and are much smaller.

In FIG. 8, there are nine Coulomb electrostatic attractive and repulsive force pairings between the two nuclei. The five attractive force pairings, shown on the left, all act parallel to the axis-of-separation. The four repulsive force pairings, shown on the right, all act at angles to the axis-of-separation. The repulsive forces begin to diminish as separation distances become small due to increasing angles. An unbalanced electrostatic attractive force then quickly builds between the two nuclei. There results a huge short-range-configuration-electrostatic-attractive-force. This attractive force is indeed a strong force with a short range occurring between neighboring nuclei.

The net attractive force for the 2.34 Fermi center-to-center separation distance shown in FIG. 8 is 5.57 Newtons. If separation distance was decreased to 1.0 Fermi, their attractive force would increase to 505.16 Newtons. In the range between 2.34 and 1.0 Fermi, this net attractive force is acting like a “1/r to the 5.3 power” force.

FIG. 9 shows these same two nuclei in the position of shuffling together. Portions of the pair are very close, producing a strong net attractive force. Whenever neutralized anti matter protons and neutralized deuterons neighbor, they share a strong attractive force causing them to fuse.

After fusing, these two nuclei dewarp and lose 30.4% of their mass. Their mass-energy yield has the enormous value 858.24 Mev per fused pair. There is 1.4 billion times more energy from a pound of fusing nuclei in stars than from a pound of burning coal on earth.

9. Modified Tokamaks and/or Stellarators

This new technology will be used to develop earth's urgent demand for future clean fusion energy production. The tasks required to achieve Anti Matter Fusion Energy Production were outlined in the author's provisional patent application (with that title) dated Nov. 18, 2019. Those tasks are reproduced here followed by a statement describing how a modified Tokamak (and/or Stellarator) machine will perform each task.

### 10. Ionize Photon-Circle Hydrogen and Photon-Circle Deuterium by Removing Their Electron.

Tokamak machines have, for more than forty years, routinely removed electrons from a variety of atoms, including Hydrogen and Deuterium. Electron removal produces the positive ionized, proton and deuteron nuclei to be used for magnetic confinement. The electrons, so removed, can now be the source of electrons needed for task 12 below.

### 11. Magnetically Orient the Resulting Photon-Circle Protons and Deuterons.

The positive charged protons and deuterons are routinely inserted into the magnetic confinement field of the Tokamak. These nuclei are structured from spinning Photon-Circle quarks. (Each quark is like a circular loop of wire that carries a current in an electric motor. The loop of wire is always torqued to a lay-flat orientation perpendicular to the motor's magnetic field.) The Tokamak machine's magnetic field will naturally orient spinning positive charged Photon-Circle protons and Photon-Circle deuterons to a flat orientation perpendicular to the Tokamak's magnetic field.

### 12. Magnetically Orient a Source of Photon-Circle Electrons.

Electrons are structured from negative charged spinning Photon-Circles. (Similar to quarks, they are also like a circular loop of wire that carries a current in an electric motor.) The Tokamak machine's magnetic field will naturally orient spinning negative charged Photon Circle electrons to a flat orientation perpendicular to the Tokamak's magnetic field.

13. Fire the Electrons with Near-Light-Speed at Target Protons and Deuterons.

Negative charged electrons, when issued into the Tokamak, will circulate in the Tokamak's magnetic field in the opposite direction to the positive charged circulating protons and deuterons. This is new to Tokamaks. They have never used electrons, in the past, as part of their Plasma. High speeds-of-approach between electrons and protons and deuterons will result.

14. The electrons will attract to, collide with, and be captured by, the protons and deuterons.

The Tokamak will, in effect, be forcing a nuclear-electron-capture type of decay. That type of decay is used naturally on earth by all the more massive stable nuclei.

15. Anti Matter Protons and Neutral Charged Deuterons will Result.

Electron capture by proton nuclei and deuteron nuclei produces anti matter protons and neutrally charged deuterons. Once electrically neutralized, anti matter protons and neutrally charged deuterons can no longer be magnetically confined. They are centrifugally thrown to the walls of the Tokamak.

16. Those that Neighbor will Attract, Fuse, Dewarp and Yield 858.24 Mev Per Fused Pair.

This fusion will happen near the outer walls of the Tokamak, i.e., near the Tokamak's heat sink used for energy absorption and energy removal for useful purposes. The energy release from Anti Matter Fusion Energy Production is a hefty 57 times more than the energy from currently studied Lithium and Deuterium Standard Model Plasma Fusion.

1. A system allowing neighboring pairs of electrically neutralized anti matter photon-circle protons with their transposed electrical charges, and electrically neutralized photon-circle deuterons, those pairs having perfect symmetry of size and shape, to share their huge attractive nuclear strong force with its 1/r to the 5.3 power short range causing their mutual attraction, fusion, relativistic dewarping and production of an enormous amount of nuclear fusion energy, a reaction that is not known to occur as a single reaction in earth's nature or in the prior fusion art, the system comprised of:
an existing Tokamak or Stellarator fusion test reactor complete with its positive charged proton and deuteron ion beam production mechanisms, its electric and magnetic fields capable of accelerating said ions and confining said ions within its evacuated structure and directing its fused products onto its energy recovery outer walls; and
an additional ion beam production mechanism producing and directing, for the first time ever, a beam of electrons into the said Tokamak or Stellarator in a direction counter current to the circulation of the positive ions and on a path so said electrons can attract to, collide with, and be captured by those positive ions and neutralize their electrical charge, the collision and combining being in effect a forced electron capture type of nuclear decay, the electrically neutralized anti matter photon-circle protons and electrically neutralized photon-circle deuterons, then leaving the magnetic confinement, going to the walls of the Tokamak or Stellarator and beginning to share their huge attractive nuclear strong force with its 1/r to the 5.3 power short range causing their pair attraction, fusion, relativistic dewarping and production of an enormous amount of nuclear fusion energy; and
the plasma heaters of said Tokamak or Stellarator being set to low or off, because of a lack of need for ion Brownian Motion to force ion collision producing fusions.
